(19) United States
(12) Patent Application Publication
(10) Pub. No.: US 2003/0032768 A1
(43) Pub. Date: Feb. 13, 2003

(54) Double end-capped polymeric biguanides

(76) Inventor: Richard Stockel, Bridgewater, NJ (US)

Correspondence Address: Richard F. Stockel, 475 Rolling Hills Road, Bridgewater, NJ, 08807, US

(21) Appl. No.: 09/908,124

(22) Filed: Jul. 18, 2001

(51) Int. Cl. C08G 73/00

(52) U.S. Cl. 528/422

(57) ABSTRACT

Linear, polymeric biguanides or salts thereof wherein the polymeric chain is terminated both at the cyanoguanidine and the amino end groups by either a C₂-C₁₄₀ primary or secondary amine or corresponding cyanoguanidine which is optionally substituted with a halogen, nitro, hydroxy, carbonyl, carboxy, mercapto, sulfoxide, sulfone, sulfonate, sulfide, ether, etc. The di end-cap polymeric biguanides have a high level of biocidal activity accompanied by a low level of toxicity to host organisms and therefore useful as biocides.

### FIELD OF THE INVENTION

The invention relates to linear polymeric biguanides (also referred to herein as “polybiguanides)” or salts thereof wherein the polymeric chain moiety is wholly or substantially wholly terminated at both the cyanoguanidine and amino end groups with a primary or secondary monoamine or monocyanoguanidine, respectively, whereby said end-groups can be alkyl, aryl, alkaryl, alicyclic, heterocyclic either substituted or unsubstituted with various functional groups, e.g., halogen, hydroxy, carboxy, sulfonate to name a few. The invention also relates to biocidal compositions having utility in disinfection and medical applications.

Background of the Invention Polymeric biguanides (and their salts thereof) having structures differing from those of the present invention is well known in the prior art. The prior art polybiguanides have structures wherein there are no modified end-groups and also when there is only one modified end-group, e.g., the cyanoguanidine end-group. Representative prior art patents comprise U.K. patents 702,268; 1,152,243; 1,167,249; 1,432,345; 1,531,717; U.S. Pate. Nos. 4,403,078, 4,558,159; 4,891,423 and 5,741,886.

By double end-capping polybiguanides the efficacy of this biocide can be tailored to enhance certain chemical/physical properties. Biocidal functional groups can be used as end-capped moieties to enhance anti-microbial activity. The hydrophilic-lipophilic balance (HLB) can be altered and whereby maximizing the ability of the polybiguanides to penetrate the outer membrane of the pathogenic organism. The end-groups can also reactive groups whereby the polybiguanides can be permanently bound to various substrates. Long chain fatty amines or aminopolyethers can confer surfactant properties (lower surface tension) to the polybiguanides.

These are just a few of the characteristics that make double end-capping unique in the synthesis of tailored polybiguanides.

### DETAILS OF THE INVENTION

The present invention comprises a linear polymeric biguanides or a salt thereof wherein the polymeric chain is wholly or substantially wholly terminated at both the cyanoguanidine and the amino end groups by a primary or secondary monoamine or monocyanoguanidine containing about 2-140 carbon atoms. The monofunctional end-groups can be aliphatic, cycloaliphatic, aryl, alkaryl, aralkyl, or heterocyclic. These end-groups can be optionally substituted with a functionality selected from the group consisting of halogen, nitro, cyano, carboxyl, hydroxyl, ester, amide, ether, sulfide, disulfide, sulfoxide, sulfone or the like.

Desirably, the polybiguanides is one, which, in the form of its free base, comprises recurring units of the general formula:

### Structure 1

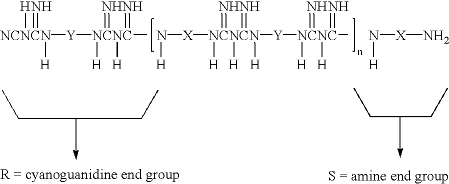

wherein X and Y are the same or different organic bridging groups. Chemically X and/or Y can be aliphatic, cycloaliphatic, heterocyclic, aryl, alkaryl, aralkyl, and combinations thereof. When X and/or Y is aliphatic the alkylene radical is from C₂-C₁₄₀, or the alkylene radical can be interrupted by oxygen, nitrogen or sulfur, e.g.,

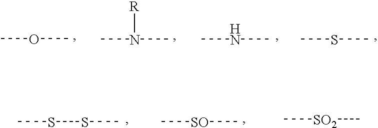

and the like where R is alkyl or aryl.

Historically, UK patents 702,268, 1,432,345 and 1,531,717 describe in general polybiguanides, which have no end-cap groups. U.S. Pat. No. 5,741,886 describes monoend-caps of polybiguanides which are detailed in the above three UK patents and in U.S. Pat. No. 4,891,423.

This invention teaches the use of double end-capping, the same classes of polybiguanides in the three UK patents and in the U.S. Pat. No. 4,891,423. These polybiguanides compositions are included in the body of this invention.

### DETAILS OF THE INVENTION

The present invention comprises a linear polymeric biguanides or a salt thereof wherein the polymeric chain is wholly or substantially wholly terminated at both the amino and the cyanoguanidine end groups by a mono cyanoguanidine and monoamine molecular respectfully.

Preferably, the monoamine or monocyanoguanidine is an aliphatic, cycloaliphatic, heterocyclic, aryl, aralkyl, alkaryl, or polyether containing oxyalkylene groups such as oxyethylene and/or oxypropylene. More preferably, the monoamine and/or monocyanoguanidine is a primary amine containing from 3-75 carbon atoms, e.g., (only monoamine examples are given, the same prefix apply for the monocyanoguanidine dodecylamine, 2-aminothiazole, 2-amino-benzothizole, polyoxyethylene monoamine, polyoxypropylene monoamine or polyoxyethylene/propylene) monoamine.

Table I gives specific examples of the wide variety of monoamines, either primary or secondary, which can be practiced in this invention. It should be fully recognized that the monocyanoguanidines can have the same prefixes, since the cyanoguanidine can be prepared by reacting the monoamine with sodium dicyanamide to yield the respective cyanoguanidine.

Furthermore the mono end-capping materials can have a wide variety of functional moieties as long as these remain relatively inactive during the synthetic modification of the polymer.

Specifically the functional moieties can be halogen, nitro, hydroxy, carboxy, ester, amide, nitrile, sulfoxide, sulfide, sulfone and the like. Anybody skilled in art of organic chemistry can reasonably predict what functionalities would be practical in the synthesis of modified polybiguanides.

TABLE I
List of Monoamines Useful to End Cap a Polybiguanide

n-laurylamine
2-aminothiazole
n-octylamine
2-aninobenzothiazole
2-amino-5-chloro-pyrimidine
3-amino-1,2,4-triazine
3-amino-1,2,4-triazine
2-(4-thiazoyl)benzimidazole
p-chlorobenzylamine
2-4-dichloroaniline
Surfonamine ™ MNPA-1000*
8-aminoguinoline
imidazole
2-amino-5-nitrothiazole
Premuline
2-amino-pyrimidine
L-tryptophane
2,3,4-trifluoroaniline
2,2,6,6-tetramethyl-4-amino piperazine
2-guanidinobenzmidazole foatnate
*Surfonamine ™ MNPA-1000 is

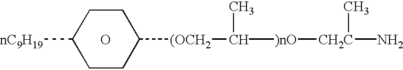

It is quite apparent that end group modification of polybiguanides is enormous, and is limited only by choosing bioactive molecules having either a primary or secondary monoamine or a monocyanoguanidine, and no very reactive functionalities which can interact with an amino or cyanoguanidine under the chosen reaction conditions of a temperature between about 100 to above 170° C. either under neat or solvent media.

The double end-capped polybiguanides of the present invention are readily prepared by a variety of multi-step processes wherein the linear, polymeric biguanides intermediates are prepared and isolated and thereafter reacted with both the monoamine and monocyanoguanidine sequentially or simultaneously.

In one type of process, the polybiguanide intermediate is prepared by reacting equimolar amounts of the desired diamine (the diamine may be one diamine or a mixture of diamines, as desired), and one mole of the desired biscyanoguanidine, or mixtures thereof, in the presence of a strong acid like hydrochloric acid. The reactants are conveniently brought into reaction by heating them neat or in an appropriate solvent at a temperature at 110° to about 190° C., preferably 130°-170° C. for a period of 2-24 ho preferably 2-8 hours. Suitable solvents are glycol ethers and other solvents, which are unreactive under these conditions.

Another method for preparing the polybiguanide intermediate involves the reaction of one mole of sodium dicyanamide and 0.5 mole of the desired diamine (one diamine or a mixture of diamines as desired) in the form of its hydrochloride salt. This reaction product intermediate is then reacted with the same or different diamine salt under the above reaction variables, resulting in the formation of a polybiguanide polymer.

The processes mentioned above for preparation of the linear, polymeric biguanides are well known in the prior art, e.g., see U.S. Pat. Nos. 2,643,232 3,428,576; 4,891,423; 5,741,886 and British Patents 702,268; 1,152,243 and 1,167,249.

The end-capped polybiguanides of the invention are readily prepared by reaction of the desired polybiguanide with the desired primary or secondary monoamine and the monocyanoguanidine, or even mixtures of both end-cap groups.

This type of modification of principally polycondensation polymers (also known as step-growth polymers) is well documented in the literature and is known to those skilled in polymer chemistry.

One method of preparation is set forth in Example I, although it should be understood that this is not the only method by which the double end-capping of polybiguanides of the present invention may be prepared. It should be understood that others prior art methods may be used to prepare such polybiguanides without departing from the spirit of the present invention.

The following examples serve to illustrate the invention.

The compound known as 1.6-di (N³-Cyano-N¹-guanidine) hexane was prepared in accordance with Example 1 of U.S. Pat. No. 4,537,746. 25.0 g (0.1 m) of hexamethylene-biscyanguanidine was combined with 14.8 g (0.1 m) of triethyleneglycoldiamine and 20 g of 37% hydrochloric acid (0.2 m) in a flask containing 20 ml distilled water. The reaction mixture was stirred and heated in an oil bath to remove the water and cause polymerization to occur. Heating at 140° to about 165° C. range with stirring for about 3-6 hours results in a quantitative yield of a white, glassy polybiguanide.

The polymer was then di end-capped as follows:

The polybiguanide from above was reheated to about 150° C. and 1.87 g (0.01 m) of n-dodecylamine was added with stirring for about two hours. This was followed by the addition 1.67 g (0.01 m) of 2-cyano-guanidine thiazole and again the polymer was heated to about 150° C. and stirred for two hours.

The di end-capped polymer gave an FTIR consistent with the expected structure.

The polybiguanides of the present invention are especially useful as the active ingredient in fungicidal or bactericidal applications, since such compositions will exhibit a high level and rate of kill for pathogens while concurrently resulting in a low level of toxicity. The polybiguanides of the present invention are effective biocidal substances, e.g., at concentrations of 1.0 to 1,000 ppm, they have been found to be effective in standard microbiological evaluations against bacteria, fungi, algae, yeasts, etc. such as S. aureus, E. coli, P. aeruginosa, A. niger and C. albicans.

The following list of double end-capped polybiguanides where tested at 10 ppm and a total kill of 10⁶ cfu's for a six hour period. All of the samples gave complete kill of the 5 organisms listed above.

Using the generic structure 1, these highly effective anti-microbial agents have the following compositions:

| R | X | Y | S |
|---|---|---|---|
| n-laurylamine | hexamethylene | hexamethylene | n-lauryl |
| | diamine | biscyanoguan- | cyanoguanidine |
| | | idine | |
| n-lauryl amine | triethylene glycol | hexamethylene | n-lauryl |
| | diamine | biscyanoguan- | cyanoguanidine |
| | | idine | |
| 2-aminothiazole | triethylene glycol | hexamethylene | n-lauryl |
| | diamine | biscyanoguan- | cyanoguanidine |
| | | idine | |
| 2-aminothiazole | hexamethylene | hexamethylene | n-lauryl |
| | diamine | biscyanoguan- | cyanoguanidine |
| | | idine | |
| 2-aminothiazole | triethylene glycol | hexamethylene | 2-aminothia- |
| | diamine | biscyanoguan- | zole cyano- |
| | | idine | guanidine |
| 2,6-dichloro- | hexamethylene | triethylene glycol | n-lauryl |
| benzyl amine | diamine | biscyanoguan- | cyanoguanidine |
| | | idine | |
| Surfonamine | triethylene glycol | hexamethylene | n-stearyl |
| MNPA-1000 | diamine | biscyanoguan- | cyanoguanidine |
| | | idine | |
| Surfonamine | triethylene glycol | hexamethylene | 3,4-dichloro- |
| MNPA-1000 | diamine | biscyanoguan- | benzyl benzyl |
| | | idine | cyanoguanidine |

The salts of these double end-capped polybiguanides can consist of a variety of acid anions having a replaceable proton in the acid-conjugate form. The anions can play an important part in both the chemical and physical of the resulting polybiguanide salt. In particularly, the anion, e.g., glyconate confers greater water solubility than does the propionate anion. In the opposite extreme a stearate salt would confer water insolubility, but the resulting polybiguanide stearate would have hydropholic solubility, e.g., in a polymer matrix.

The desired salts of the polybiguanides of this invention are chloride, bromide, iodide, tri-iodide, pentaiodide, citrate, gluconate, acetate, stearate. In general, carboxylic acids, which are aliphatic, cyclo-aliphatic, heterocyclic, aryl, alkaryl, or aralkyl with C₂-C₂₂ are functional. Hydroxy and polyhydroxy carboxylic acid are also useful to yield the protonated polybiguanide.

From the above description, one skilled in the art can easily ascertain the essential characteristics of the present invention, and without departing from the spirit and scope thereof, can make various changes and modifications of the invention to adapt it to various usages and conditions.

What is claimed is:

1. A linear polymeric biguanides or a salt thereof wherein the polymeric chain is wholly or substantially wholly terminated both at the cyanoguanidine end group by a primary or secondary monoamine containing 2-140 carbon atoms, and at the amino end group by a monocyanoguanidine containing from 2-140 carbon atoms, said monoamine and/or monocyanoguanidine being optionally substituted with a functionality selected from the group consisting of fluoride, chloride, bromide, iodide, triiodide, pentaiodide, nitro, hydroxyl, ether, ester, amide, sulfide, disulfide, sulfoxide and sulfone, said polymeric biguanides, in the form of its free base, comprising recurring units of the general structure: 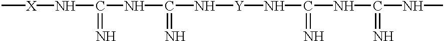
Wherein X and Y are the same or different organic radical bridging groups.

2. The polymeric biguanides of claim 1 wherein the monoamine is selected from the group consisting of aliphatic, cycloaliphatic, heterocyclic, aryl, aralkyl, alkaryl, polyether monoamines containing oxyalkylene groups, polyamines, polysulfides, sulfoxides or sulfones.

3. The polymeric biguanides of claim 1 where in the monocyanoguanidine is selected from the group consisting of aliphatic, cycloaliphatic, heterocyclic, aryl, aralky, alkaryl, polyester containing oxyalkylene groups, polyamine, polysulfide, sulfoxide, or sulfone mono cyanoguanidines.

4. The polymeric biguanides of claim 1 where in the monoamine is selected from the group consisting of aliphatic, cycloaliphatic, heterocyclic, aryl, aralky, alkaryl, polyethers containing oxyalkylene groups, polyamines, polysulfide, or sulfone monoamines.

5. The polymeric biguanides of claim 3 wherein the monocyanoguanidine contains 2-140 carbon atoms.

6. The polymeric biguanides of claim 5 wherein the monocyanoguanidine is unsubstituted.

7. The polymeric biguanides of claim 4 wherein the monoamine is a primary amine containing 2-140 carbon atoms.

8. The polymeric biguanides of claim 7 wherein the monoamine is unsubstituted.

9. The polymeric biguanides of claim 6 wherein the monocyanoguanidine is selected from the group consisting of n-dodecylcyanoguanidine, 2-cyanoguanidine thiazole, 2-cyanoguanidine of benzotriazole, polyoxyethylene monocyanoguanidine, polyoxypropylene cyanoguanidine, and polyoxy (ethylene/propylene) monocyanoguanidine.

10. The polymeric biguanide of claim 8 wherein the monoamine is selected from the group consisting of n-dodecylamine, 2-aminothiazole, 2-aminobenzotriazole, polyoxyethylene monoamine, polyoxypropylene monoamine and polyoxy (ethylene/propylene) monoamine.

11. The polymeric biguanide of claim 1 wherein the organic radicals represented by X and Y are the same or different C₂-C₁₄₀, aliphatic, cycloaliphatic, heterocyclic, aryl, alkaryl, aralkyl or oxyalkylene radicals.

12. The polymeric biguanide of claim 11 wherein X is a polyoxyalkylene radical and Y is a polyalkylene radical optionally interrupted by nitrogen, oxygen or sulfur atoms or by saturated or unsaturated cycli nuclei.

13. The polymeric biguanide of claim 12 wherein Y is a C₂-C₂₂ polymethylene radical.

14. The polymeric biguanide of claim 13 wherein X is a polyoxyalkylene radical derived from the amines selected from the group consisting of:
(a) amine-terminated polypropylene glycols having the structure: 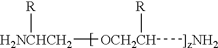
wherein R is H or CH₃, and Z has a value of about 1 to 68;
(b) polyether diamines having the structure: 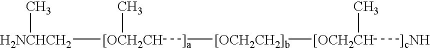
wherein b has a value of about 8.5 to about 131.5 and the value of a and c is about 2.5;
(c) urea condensates of amine-terminated polypropylene glycols having the structure: 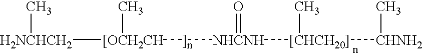
wherein n has a value of about 2.6;
(d) amine terminated polyethylene glycols having the structure: 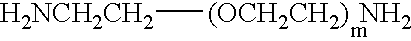
wherein m has a value of about 1 to 4; and
(e) amine terminated propylene glycols having the stucture: 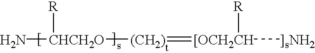
wherein s has a value of 1 to about 10; t has a value of 2-22; and R is hydrogen or methyl.

15. The polymeric biguanide of claim 14 wherein the polyoxyalkylene radical is derived from amine terminated polyethylene glycols having the structure: 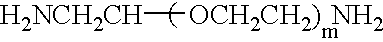
wherein m has a value of about 1 to 4.

16. The polymeric biguanide of claim 1 where in the salt comprises chloride, bromide, iodide, alkyl sulfonate, aryl sulfonate, sulfate, alkyl sulfate, or aryl sulfate.

17. The polymeric biguanides of claim 1 where in the salt comprises alkyl, aryl, heterocyclic, cycloaliphatic carboxylic acid.

18. The polymeric biguanides of claim 17 wherein the carboxylate is acetate, benzoate or stearate.

19. The polymeric biguanides of claim 1 where in the salt comprises hydroxy carboxylic acids.

20. The polymeric biguanides of claim 19 wherein the hydroxy carboxylates are glycolate, gluconate, citrate, lactate, mandelate, salicylate and tartarate.

21. A bactericidal composition comprising as the active ingredient, the polymeric biguanide of claim 1, together with a carrier substance thereof.
